(19) United States
(12) Patent Application Publication
(10) Pub. No.: US 2011/0023800 A1
(43) Pub. Date: Feb. 3, 2011

(54) MIRROR-IMAGE CYLINDER HEADS

(75) Inventors: David Curtis Ives, Ann Arbor, MI (US); Bradley David Opperman, Belleville, MI (US); Patrick Brian Morgan, New Baltimore, MI (US)

Correspondence Address: BROOKS KUSHMAN P.C./FGTL, 1000 TOWN CENTER, 22ND FLOOR, SOUTHFIELD, MI, 48075-1238, US

(73) Assignee: FORD GLOBAL TECHNOLOGIES, LLC, Dearborn, MI (US)

(21) Appl. No.: 12/533,377

(22) Filed: Jul. 31, 2009

(51) Int. Cl. F02B 75/22

(52) U.S. Cl. 123/54.4

(57) ABSTRACT

A vee-engine has left and right cylinder banks have valve configurations that are mirror images of each other. The exhaust valves and associated exhaust ports are situated more toward the rear of the engine than the intake valves in any particular cylinder. With all the exhaust valves nearer the rear of the engine, the overall exhaust manifold runner length between the ports and the turbocharger is reduced relative to an engine with offset cylinder banks where exhaust valves in one bank are located nearer the front of the engine than exhaust valves of the other bank.

### BACKGROUND

1. Technical Field

The present disclosure is related to right and left cylinder heads for a vee-configured internal combustion engine.

2. Background Art

In current vee-configured engines, the left and right bank cylinder heads are configured so that a majority of the machining operations can be completed on a single manufacturing and valve assembly line. To accommodate the single machining line, the valve placements in the two cylinder heads are identical. So that the intakes all exit the head into the valley of the engine or, alternatively that all the exhausts exit the head into the valley, one end of a first cylinder head is placed on the left bank of engine cylinders facing toward the front of the engine and the one end of a second cylinder head is placed on the engine with that one end facing toward the rear of the engine.

When the exhaust is inboard, it is important to ensure that the exhaust is quickly conducted away from the valley to reduce heat transfer from the exhaust runners to various components in the valley. Also, it is important that the exhaust gas entering the turbocharger, in engines so equipped, and aftertreatment devices is as warm as possible to allow fast warmup of the aftertreatment devices and to reduce turbocharger lag. Although suitable for many applications, one disadvantage of using such a single cylinder head design having a first end of the first cylinder head on the front of one cylinder bank and the first end of the second cylinder head on the back of the other cylinder bank is that the exhaust valves of one cylinder bank are displaced toward the front of the engine relative to the other, where the exhaust valves are displaced toward the rear of the engine. As a result, the exhaust manifold must conduct the exhaust gases further to the exhaust system for one of the cylinder banks.

Packaging volume for engine accessories in the valley of the engine is at a premium; a longer exhaust manifold exacerbates this problem.

Yet another disadvantage of using a single head configuration and mounting one forward on a left cylinder bank and mounting one rearward on a right cylinder bank is that features such as the water jacket, glow plug positioning, etc., may be compromised by using a single cylinder head design for both banks of cylinders.

### SUMMARY

An internal combustion engine with left and right cylinder banks, according to an embodiment of the present disclosure, has a left cylinder head bolted to the left bank of engine cylinders and a right cylinder head bolted to the right bank of engine cylinders. Each cylinder has at least one intake valve and one exhaust valve. In each cylinder of both banks, the associated exhaust valve is located rearward with respect to the associated intake valve. Exhaust ports lead from the exhaust valve and exit into an exhaust manifold. In one embodiment, the exhaust ports exit generally normal to the side of the cylinder head. In an engine in which there are two intake valves and two exhaust valves per cylinder that are actuated by a single camshaft, the exhaust valves associated with any one cylinder are more rearward than the two intake valves associated with the one cylinder.

By using two separate castings for the two cylinder heads and machining them according to separate specifications, the exhaust ports for all cylinders are located more toward the rear of the engine where the turbocharger is located. This provides an advantage over the prior art in which the exhaust valves and exhaust ports in one cylinder head are located more toward the front of the engine or longitudinally offset relative to the other cylinder head. According to an embodiment of the disclosure with exhaust valves closer toward the rear of the engine in both heads, the exhaust manifold surface area radiating to the rest of the engine is less, the length of travel for the exhaust to enter the turbocharger is shorter, and the exhaust manifold takes up less volume, which allows space for other components in the crowded valley of the engine.

In an alternative embodiment, the exhaust ports within the cylinder head direct the flow toward the rear of the engine. If such an exhaust port arrangement were used on an engine according to the prior art with identical cylinder heads, the exhaust is efficiently directed toward the turbocharger on only one of the cylinder heads. The exhaust from the other cylinder head must be turned by more than a 90 degree angle to be directed toward the turbocharger. According to an embodiment of the present disclosure, mirror image cylinder heads direct the flow from both cylinder heads toward the rear of the engine, making the exhaust manifold runners even shorter and the angle which the flow is turned to direct the exhaust toward the rear of the engine is less than 90 degrees for both left and right sides of the engine.

### BRIEF DESCRIPTION OF THE DRAWINGS

FIG. 1 is a front view of a vee-configured engine having left and right cylinder banks and left and right cylinder heads;

FIG. 2 is a plan view of a vee-configured engine in cross section showing two identical heads mounted in opposite directions on the two banks;

FIG. 3 is a plan view of a vee-configured engine in cross section showing a cross section of engine cylinder heads configured according to one embodiment of the present disclosure;

FIG. 4 is a plan view of a cylinder head according to an embodiment of the present disclosure with the intake and exhaust valves installed; and

FIG. 5 is a plan view of an engine.

### DETAILED DESCRIPTION

As those of ordinary skill in the art will understand, various features of the embodiments illustrated and described with reference to any one of the Figures may be combined with features illustrated in one or more other Figures to produce alternative embodiments that are not explicitly illustrated or described. The combinations of features illustrated provide representative embodiments for typical applications. However, various combinations and modifications of the features consistent with the teachings of the present disclosure may be desired for particular applications or implementations. The representative embodiments used in the illustrations relate generally to cylinder head configuration in internal combustion engines having two cylinder banks. Those of ordinary skill in the art may recognize similar applications or implementations consistent with the present disclosure, e.g., ones in which components are arranged in a slightly different order than shown in the embodiments in the Figures. Those of ordinary skill in the art will recognize that the teachings of the present disclosure may be applied to other applications or implementations.

Words and phrases indicating direction or orientation, such as left, right, front, back, top, bottom, etc. generally refer to the engine as illustrated in the representative embodiments when installed longitudinally in a vehicle and are used for convenience only in describing the Figures. Those of ordinary skill in the art will understand the teachings of the present disclosure may be applied to applications and implementations with engines having orientations or configurations different from those illustrated and described.

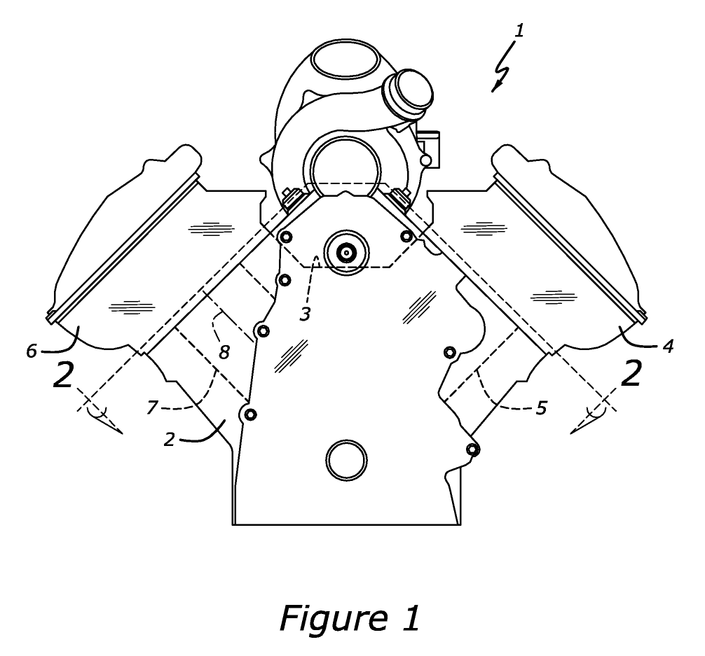

FIG. 1 illustrates a view of a front of engine 1 with a cylinder block 2 and a valley 3. A left cylinder head 4 is coupled to a left bank of cylinders 5 and a right cylinder head 6 is coupled to a right bank of cylinders 7. Because this is a front view, all cylinders in a bank line up and, thus, the position of the front cylinder in the bank is visible. A centerline 8 of the front cylinder of right bank cylinder 7 is shown. The angle between left bank 5 and right bank 7 cylinders is 90 degrees in FIG. 1. However, the included angle may be in the range of 60 to 90 degrees. Also shown in FIG. 1 is a cross section (2-2) through cylinder head 6 at an angle roughly perpendicular to cylinders 7, across the top of engine 1, and through cylinder head 4 at an angle roughly perpendicular to cylinders 5.

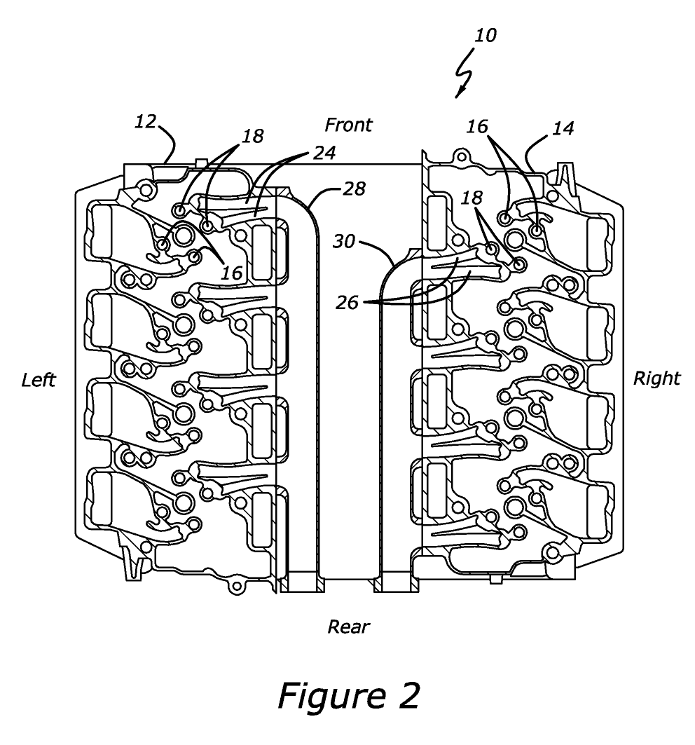

FIG. 2 illustrates a cylinder head arrangement having identical cylinder heads and an inboard exhaust representative of prior art implementations. An offset cross-sectional view of (cross section of FIG. 1) a vee engine 10 is shown having two cylinder heads 12 and 14 that having two intake valves and two exhaust valves per cylinder. Because FIG. 2 shows a cross section of the heads, the valves are not shown. Instead, 16 and 18 refer to holes to accommodate valve stems of intake valves and 20 and 22 refer to holes to accommodate the valve stems of exhaust valves. The valves are not shown, but their relative positions are defined by valve stem holes 16, 18, 20, and 22. The valves are situated in such a manner that they can be actuated by a single camshaft running lengthwise down the cylinder head. Due to the placement of the valves in the cylinder head, in particular, the exhaust valves of each cylinder are further forward than the associated intake valves, so that exhaust ports 24 exit cylinder head 12 further forward as compared to exhaust ports 26 exiting cylinder head 14. Consequently, an exhaust manifold 28 coupled to cylinder head 12 has a longer run to couple to the turbocharger (not shown) than exhaust manifold 30 coupled to cylinder head 14. When the exhaust is inboard such as in FIG. 1, it is important to ensure that the exhaust is quickly conducted away from the valley with a minimum of heat transfer so that the components in the valley are heated as little as possible due to heat transfer from the exhaust runners. Thus, exhaust manifold 28 is less than optimal since it is substantially longer than exhaust manifold 30.

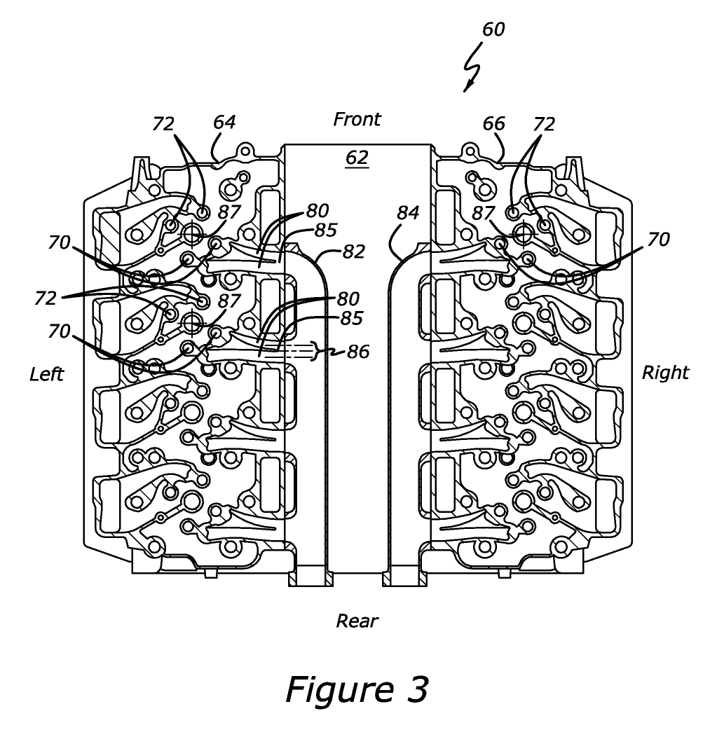

In FIG. 3, an offset cross section of an engine 60, according to an embodiment of the present disclosure is shown, cross section 2-2 from FIG. 1. Engine 60 has a cylinder block (only the valley 62 of the cylinder block is visible in the view of FIG. 3). A left cylinder head 64 is coupled to left bank cylinders (not shown) and a right cylinder head 66 is coupled to right bank cylinders (not shown). Engine 60 has two intake valves and two exhaust valves associated with each cylinder. In the view of FIG. 3, the valves are not shown. However, the positions of the valves are defined by the valve stem holes in the cylinder heads with holes 70 indicating the positions of exhaust valves and holes 72 indicating the positions of intake valves. The valves in left cylinder head 76 are arranged in a mirror image with respect to the valves in right cylinder head 78. In all cylinders, the exhaust valves associated with a particular cylinder are located more toward the rear of engine 60 than the intake valves associated with that particular cylinder.

The valve arrangement illustrated in FIG. 3 shows valve arrangement in contrast with the valve arrangement illustrated in FIG. 2 where the exhaust valves in each left bank cylinder are forward of the intake valves. Exhaust ports 24 exit further forward on left cylinder head 12 so that exhaust manifold 28 is longer by about 20% than exhaust manifold 26 in FIG. 2 or exhaust manifold 82 in FIG. 3.

In FIG. 3, an exhaust port 80 is provided for each exhaust valve to direct flow from the exhaust valve to one of exhaust manifold 82 and 84. In the embodiment shown in FIG. 3, the two exhaust ports from each cylinder join into a joined exhaust port 85 before exiting the cylinder head. Alternatively, these ports remain separated through the head. In FIG. 3, a centerline of individual exhaust ports 80 and of joined exhaust port 85 is shown for a representative cylinder. In the embodiment of FIG. 3 exhaust port centerlines (labeled 86) are roughly normal, at least near the exit from the cylinder head, to the side of cylinder head 64 from which the ports exit. Individual exhaust ports 80 and joined exhaust ports 85 direct the flow toward valley 62 of engine 60. In an alternative embodiment, all exhaust port centerlines form an angle with the side of cylinder head 64 such that individual exhaust ports 80 and joined exhaust ports 85 direct the flow generally toward the valley 62 of engine 60 and generally toward a rear of the engine 60.

In FIG. 3, a centrally-mounted injector hole 87 for each cylinder shown (labeled only for a few representative cylinders). The center of the injector hole, which is denoted by cross-hairs for representative cylinders, is coincident with the axis of the cylinder in this embodiment. However, the present disclosure applies, also to engines with injectors mounted off-axis. The cross-sectional representation of FIG. 3 is not along a straight line, but taken along several lines. Thus, although the cylinder axes of cylinders in head 64 appear as parallel to cylinder axes of cylinder 66, this is only due to the cross section (section 2-2 in FIG. 1).

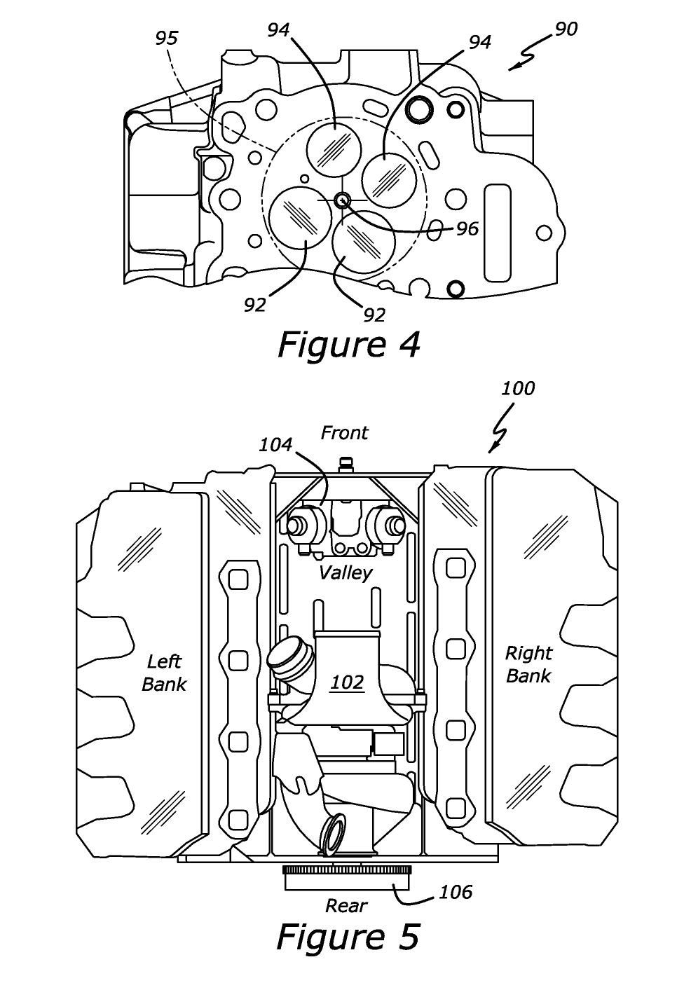

In FIG. 4, a plan view of a cylinder head 90 from an underside (face of cylinder head which sits next to the cylinder block) is shown with the intake valves 92 and exhaust valves 94 installed. Dotted circle 95 shows the location that the cylinder block mates with cylinder head 90 when assembled. Injector mounting hole 96 is centrally mounted and generally coaxial with the axis of the cylinder. In an alternative embodiment, the injector is displaced from the center, in which case the axis of the cylinder is not coaxial.

In FIG. 5, a plan view of an engine 100 shows a turbocharger 102 mounted in the valley 104 of engine 100 and a fuel pump also mounted in valley 104, but near the front of engine 100. A flywheel 106 is shown at the rear of the engine.

As such, embodiments of the present disclosure use two separate castings for the two cylinder heads and machine them according to separate specifications to locate the exhaust ports for every cylinder closer to the turbocharger to reduce turbocharger wind-up time, reduce heat rejection, and improve turbocharger performance while increasing available packaging space in the valley.

While the best mode has been described in detail, those familiar with the art will recognize various alternative designs and embodiments within the scope of the following claims. For example, the engine described with respect to FIG. 3 has an inboard exhaust. The present disclosure applies to a cross-flow configuration in which the engine intake is inboard and the engine exhaust is outboard. Also, the exhaust ports 80 in FIG. 3 exit substantially normal from the side of the cylinder head. However, the exhaust ports can be angled toward the rear of the engine, which would reduce the length of exhaust manifolds 82 and 84 even more. Where one or more embodiments have been described as providing advantages or being preferred over other embodiments and/or over prior art in regard to one or more desired characteristics, one of ordinary skill in the art will recognize that compromises may be made among various features to achieve desired system attributes, which may depend on the specific application or implementation. These attributes include, but are not limited to: cost, strength, durability, life cycle cost, marketability, appearance, packaging, size, serviceability, weight, manufacturability, ease of assembly, etc. The embodiments described as being less desirable relative to other embodiments with respect to one or more characteristics are not outside the scope of the disclosure as claimed.

What is claimed:

1. An internal combustion engine, comprising:
a vee-configured cylinder block having left bank cylinders and right bank cylinders;
an exhaust valve associated with each cylinder;
an intake valve associated with each cylinder wherein within each cylinder, the associated exhaust valve is situated closer to one end of the engine than the associated intake valve for all cylinders of the engine.

2. The engine of claim 1 wherein the one end is a front end of the engine.

3. The engine of claim 1 wherein the one end is a rear end of the engine.

4. The engine of claim 1, further comprising:
a left cylinder head bolted to the left bank cylinders;
a right cylinder head bolted to the right bank cylinders; and
an exhaust port in the left cylinder head and the right cylinder head for each exhaust valve wherein a centerline of all exhaust ports exiting the cylinder head is directed generally toward a valley of the cylinder block in between the left and right banks and generally toward a rear of the engine.

5. The engine of claim 1, further comprising:
a second exhaust valve associated with each cylinder;
an exhaust port in the left cylinder head and the right cylinder head for each exhaust valve wherein each exhaust port pair associated with a particular cylinder joins to form a joined exhaust port and a centerline of all joined exhaust ports exiting the cylinder head is directed generally toward a valley of the cylinder block in between the left and right banks.

6. The engine of claim 1, wherein in between the left and right banks is a valley, the engine further comprising:
a fuel pump mounted to the block in the valley at a front of the engine: and
a turbocharger mounted to the block in the valley near a rear of the engine.

7. An internal combustion engine, comprising:
a vee-configured cylinder block having left bank cylinders coupled to a left cylinder head and right bank cylinders coupled to a right cylinder head;
two intake valves disposed in the cylinder heads for each cylinder; and
two exhaust valves disposed in the cylinder heads for each cylinder,
wherein within each cylinder, the associated exhaust valves are located more toward the rear of the engine than the associated intake valves.

8. The engine of claim 7 wherein the left and right banks of engine cylinders form an angle of between about 60 to 90 degrees.

9. The engine of claim 7 wherein the right and left cylinder heads have an exhaust port leading from each valve and the exhaust ports associated with a particular cylinder together form a joined port such that the right and the left cylinder heads have one exhaust passage per cylinder exiting the cylinder heads, and a centerline of all the joined ports exit toward a valley of the engine.

10. The engine of claim 8 wherein all the joined ports, in addition to being directed toward a valley of the engine are directed generally toward the rear of the engine.

11. The engine of claim 7 wherein the rear of the engine is an end of the engine adapted to couple to a flywheel.

12. The engine of claim 7 wherein the right and left cylinder heads have an exhaust port leading from each valve and a centerline of the exhaust ports exit toward the rear of the engine.

13. An internal combustion engine, comprising:
a vee-configured cylinder block having left bank cylinders and right bank cylinders;
a left cylinder head coupled to the left bank cylinders;
a right cylinder head coupled to the right bank cylinders; and
at least one exhaust valve per cylinder mounted in the heads wherein each exhaust valve is located more toward the rear of the engine with respect to an axis of the associated cylinder.

14. The engine of claim 13, further comprising:
at least one intake valve per cylinder installed in the heads wherein in each cylinder, the associated exhaust valve is situated more rearward that the associated intake valve.

15. The engine of claim 13 wherein each cylinder has two exhaust valves, the engine further comprising:
two intake valves per cylinder, wherein in each cylinder, the exhaust valves associated with a particular cylinder are located more toward the rear of the engine than the intake valves associated with the particular cylinder.

16. The engine of claim 13 wherein each exhaust valve has an associated exhaust port within the associated cylinder head and all exhaust ports are directed from the exhaust valve generally toward a valley of the engine, the valley being between the left bank cylinders and the right bank cylinders.

17. The engine of claim 16 wherein each exhaust port is directed generally from the exhaust valve toward a rear of the engine.
